(19) United States
(12) Patent Application Publication
(10) Pub. No.: US 2014/0104758 A1
(43) Pub. Date: Apr. 17, 2014

(54) Switching Device And A Switchgear

(71) Applicants: Tom-Rune Bjortuft, Porsgrunn (NO); Thor Endre, Skien (NO); Paal Kristian Skryten, Skien (NO); Havard Hadland, Skien (NO); John-Anders Tveten, Porsgrunn (NO); Stanley Lohne, Porsgrunn (NO)

(72) Inventors: Tom-Rune Bjortuft, Porsgrunn (NO); Thor Endre, Skien (NO); Paal Kristian Skryten, Skien (NO); Havard Hadland, Skien (NO); John-Anders Tveten, Porsgrunn (NO); Stanley Lohne, Porsgrunn (NO)

(21) Appl. No.: 14/107,782

(22) Filed: Dec. 16, 2013

Related U.S. Application Data
(63) Continuation of application No. PCT/EP2011/060060, filed on Jun. 16, 2011.

(51) Int. Cl. H02B 5/00

(52) U.S. Cl. CPC H02B 5/00
USPC 361/605; 361/673

(57) ABSTRACT

A switching device for electric power distribution, includes a breaker that is electrically connectable to a conductor, and an electrically conductive housing to which the breaker is mounted. The device provides a current path between the breaker and the conductor. The housing houses at least one guiding member for operating the breaker and a first part of the current path, the first part being electrically connected to the breaker. The device also includes a switch for electrically connecting the breaker to the conductor, the switch having a switch element movable to a first position where the switch element is connected to the first part and the conductor, movable to a second position where the switch element is disconnected from the conductor and connected to the first part and a grounded element, and movable to a third position where the switch element is disconnected from the conductor and the grounded element.

### FIELD OF THE INVENTION

The present invention relates to a switching device for electric power distribution, that is electrically connectable to an electrical conductor. The switching device comprises a breaker, which is electrically connectable to the electrical conductor, and a housing to which the breaker is mounted, wherein the housing is at least partially electrically conductive. The switching device provides a current path between the breaker and the electrical conductor. The housing houses at least one guiding member for operating the breaker, the at least one guiding member being movable in relation to the housing. The housing houses a first part of the current path between the breaker and the electrical conductor, the first part of the current path being electrically connected to the breaker. The housing also has an outer surface. Further, the present invention relates to a switchgear comprising at least one switching device of the above-mentioned sort.

### BACKGROUND OF THE INVENTION

Switchgears for medium and/or high voltage, e.g. 1-1000 kV, such as 12, 24 or 36 kV, of prior art normally comprise one to five modules housed in a casing, or encapsulation, and each module comprises at least three electrical bushings (one for each phase of a three phase AC power distribution system), conductors leading from each electrical bushing to a respective breaker (e.g. a vacuum interrupter), selector switches (one for each breaker), and busbars (one for each phase). The selector switches are used for connecting the breaker to the busbars or disconnecting them from the latter. Each selector switch normally comprises a switch knife movable between positions in which it is connected to or disconnected from the busbar.

The breaker is often a vacuum interrupter, which may be spring loaded, and is provided to interrupt the electric circuit upon occurrence of specific operational conditions. After such breaking, the selector switches may be manually or automatically disconnected from the respective busbar, either to a position in which the selector switch is connected to ground or an open position in which, for example, electric measurements on the components on the breaker side of the switch may be performed.

Examples of switchgears are disclosed in each of US2008/0217153 A1, US2004/0104201 A1 and DE 3528770 A1. For each phase, the switchgear has a breaker, a busbar and a movable switching element which is pivotable between a first position, in which the switching element electrically connects the breaker to the busbar, a second position, in which the switching element is connected to ground/earth, and a third position, in which the switching element is disconnected from both the busbar and ground, the third position corresponding to a switched-off position.

US 2005/0241928 A1 discloses an electric power interrupter with an internal contactor for use as a line or load switch constructed from light weight materials.

U.S. Pat. No. 3,919,511 discloses a circuit breaker equipped with a mechanism housing which is partly covered by half-shells consisting of electrically conductive material in order to not impair the electric field in the interior of the breaker housing.

U.S. Pat. No. 5,057,654 discloses an interrupter switch assembly provided with an interrupter unit having a moulded housing and a cover portion with which a conductive portion of a conductive shunt current path is integrally moulded, the conductive portion being generally a thin member or strip.

US 2002/0179571 A1 discloses an electrical circuit interrupter device for a power distribution system, comprising a housing made of a conductive material, e.g. aluminium, forming part of the electrical connection between a first terminal and a second terminal. The housing is connected to a circuit interrupter, e.g. a vacuum interrupter, situated between the first terminal and the housing, and the housing houses a manual handle and lever mechanism assembly for operating the circuit interrupter. Alternatively, the housing is made of a non-conductive material with a conductive shunt forming part of the electric connection between the first and second terminals.

WO 2004/032298-A1 discloses a gas-insulated switch of a compact structure including a vacuum interrupter, where components are fixed to and electrically connected to conductive cases for mitigating the electric field of a movable contact unit of each component.

U.S. Pat. No. 5,003,427 discloses a metal enclosed multi-phase high voltage switching arrangement, including a busbar, a power switch and a three-way switch.

U.S. Pat. No. 5,276,286 discloses an exposed outdoor disconnector for operating under icing conditions, including a vacuum switch mounted to a protective metal cover, the metal cover housing members for operating the vacuum switch. JP2001 143582-A discloses a vacuum breaker connected to a housing. WO 01/78100-A1 discloses an isolating circuit breaker for pole mounting including a vacuum interrupter mounted to a housing made of a metallic material. The housing houses a guiding member for operating the vacuum interrupter.

EP 2 180 490-A1, US 2008/0217153-A1, US 2004/0104201-A1 and DE 35 28 770-A1 disclose a switching device comprising a breaker and a switch element pivotable about a pivot axis between three positions. In a first position, the switch element is electrically connected to the breaker and a bus bar. In a second position, the switch element is electrically connected to the breaker and a grounded element. In a third position, the switch element is disconnected from both the busbar and the grounded element.

### SUMMARY OF THE INVENTION

Switchgears should be designed to prevent the occurrence of discharges, arcs or flashover between components of the switchgear. Prior art switchgears may require too much space in order to fulfil safety regulations, i.e. in order to prevent the occurrence of discharges or arcs. However, at the same time, there is a need for compact switchgears which require less space, but still with assured safety against disruptive discharge.

An object of the present invention is thus to reduce the risk of flashover, discharges or arcing between components or units of a switchgear.

A further object of the present invention is to provide a switchgear which has a compact design.

The above-mentioned objects of the present invention is attained by providing a switching device for electric power distribution, that is electrically connectable to an electrical conductor, the switching device comprising a breaker, the breaker being electrically connectable to the electrical conductor, and a housing to which the breaker is mounted. The switching device provides a current path between the breaker and the electrical conductor. The housing houses at least one guiding member for operating the breaker, the at least one guiding member being movable in relation to the housing, and houses a first part of the current path between the breaker and the electrical conductor, the first part of the current path being electrically connected to the breaker. The housing has an outer surface, wherein the switching device comprises a switch for electrically connecting the breaker to the electrical conductor. The switch comprises a switch element movable to a first position in which the switch element is electrically connected to the first part of the current path and to the electrical conductor, movable to a second position in which the switch element is disconnected from the electrical conductor and electrically connected to the first part of the current path and to a grounded element, and movable to a third position in which the switch element is disconnected from the electrical conductor and from the grounded element.

By placing the first part of the current path, which is electrically connected (i.e. in conductive contact) to the switch element in the first and second positions, within the housing so that the first part of the current path is housed in the housing, the outer surface of the housing may be given a particularly smooth outer shape. Consequently, the electric field, or electric field stress, generated by the voltage of the current through the switching device is evenly distributed in an efficient way, and the risk of flashover, discharges or arcing between the components of the switching device and between the housing and the surroundings, e.g. the housing of a switching device of another phase, or ground, is efficiently reduced. As a result, the switchgear provided with one or a plurality of the switching devices according to the present invention can be made more compact and less bulky, and less space for the switchgear is thus needed. Especially, when installed, the vertical extension of the switching device and the switchgear may be efficiently reduced, providing an efficient compactness. Further, any additional shielding of the electric field may be avoided. The provision of the at least one guiding member for operating the breaker inside the housing also contributes to an even distribution of the electric field. The switching device may be used for a plurality of different applications, such as a load break switch application and a circuit breaker application, without any, or at least without any substantial, design alterations. The switching device is easy to assemble and install and may be pre-assembled before arriving at the operation site, which facilitates the installation work.

As a result of the improved switching device, the need for electrically insulating gas inside an encapsulation where the switching device is housed may be reduced, and possibly air instead of, for example, SF₆, may be used. However, the switching device of the present invention can advantageously be combined with encapsulations containing any insulating gas, e.g. SF₆, and the housing of the switching device may also be filled with, or contain, any insulating gas.

The breaker is adapted to open/interrupt the current path and adapted to close the current path. There are several prior art breakers well known to the person skilled in the art. A breaker has at least two states. In a closed or conductive state, the breaker conducts current, and in an open or non-conductive state, the breaker breaks/interrupts the current path through it and the breaker is substantially non-conductive and does not conduct any current. Conventionally, a breaker is adapted to detect a fault condition and break the current upon fault detection. Thereafter, the breaker may be reset (manually or automatically) to resume normal conducting operation.

According to an advantageous embodiment of the switching device according to the present invention, the breaker is a vacuum interrupter, but the breaker can be in the form of any suitable type of breaker, such as a SF₆ gas interrupter.

According to an advantageous embodiment of the switching device according to the present invention, the switching device comprises the electrical conductor.

Advantageously, the electrical conductor is a busbar, but can also be in the form of any other electrical conductor. Advantageously, the housing is made of a suitable electrically conductive material, e.g. aluminium, such as cast aluminium. However, the housing can also be made of copper, zinc, a conductive polymer material, or any other suitable electrically conductive material. Casting or moulding an aluminium housing is a non-expensive procedure. Advantageously, the housing is plated with nickel or silver at certain locations, e.g. at electric connection areas.

Advantageously, the greater part of the breaker may be located outside of the housing. Advantageously, the at least partially electrically conductive housing is electrically conductive.

The housing may comprise an opening, e.g. a slot, for receiving at least a portion of the switch element.

According to a further advantageous embodiment of the switching device according to the present invention, the switch element in the first position is electrically connectable to an electrical conductor located outside of the housing. By means of this embodiment, the compactness of the switchgear is further improved.

In the second position, the switch element may be electrically connectable to a grounded element located outside of the housing.

According to yet another advantageous embodiment of the switching device according to the present invention, the switch element in the third position is situated within the outer surface of the housing. By means of this embodiment, the switch element may be completely shielded by the housing. The dielectric performance of the switching device is not impaired, and the distribution of the electric field and of the electric field stress is further improved. Further, the compactness of the switchgear may be further improved.

According to still another advantageous embodiment of the switching device according to the present invention, the switch element in the third position is electrically connected to the first part of the current path. By means of this embodiment, the distribution of the electric field and of the electric field stress and the compactness of the switchgear are further improved.

According to yet another advantageous embodiment of the switching device according to the present invention, the switch element is pivotable about an axis of rotation and pivotable between the first, second and third positions. This is an efficient way of moving the switch element between its different positions, which supports the compact design of the switchgear.

According to an advantageous embodiment of the switching device according to the present invention, the axis of rotation of the switch element is located outside of the outer surface of the housing. By means of this embodiment, the switch element may be pivotally mounted to an axis of rotation outside the housing, and the distribution of the electric field and of the electric field stress is further improved. Alternatively, the axis of rotation of the switch element is located inside of the outer surface of the housing.

According to another advantageous embodiment of the switching device according to the present invention, the axis of rotation of the switch element is located outside of the switch element. This embodiment supports the efficient movement of the switch element between its different positions.

The switch element may have an elongated extension. The switch element may define a longitudinal axis along the elongated extension, and the longitudinal axis of the switch element may be displaced from the axis of rotation of the switch element. Alternatively, the axis of rotation of the switch element may intersect the switch element.

According to still another advantageous embodiment of the switching device according to the present invention, the switch element has a first end portion and a second end portion between which the switch element extends, wherein in the first position the first end portion of the switch element is electrically connected to the first part of the current path and the second end portion of the switch element is electrically connected to the electrical conductor, and in the second position the second end portion of the switch element is disconnected from the electrical conductor and electrically connected to the first part of the current path and the first end portion of the switch element is electrically connected to the grounded element. By means of this embodiment, the distribution of the electric field and of the electric field stress and the compactness of the switchgear are further improved.

According to another advantageous embodiment of the switching device according to the present invention, the switch element extends non-linearly from the first end portion to the second end portion. The switch element may extend along an arced or curved shape or a V-shape, from the first end portion to the second end portion. By means of this embodiment, the electrical distance, i.e. the length of the current path, from the first end portion to the second end portion is longer than the geometric distance between the first end portion and the second end portion of the switch element. Thus, the switch element may provide a sufficiently long electrical distance but may still be housed in a compact housing because of its advantageous geometric shape. The “arced” shape of the switch element further enhances the compactness of the housing, the switching device and the switchgear. When the switch element is pivotable about an axis of rotation, the switch element may form a convex shape towards the axis of rotation of the switch element.

According to yet another advantageous embodiment of the switching device according to the present invention, in the third position, the first and second end portions of the switch element are electrically connected to the first part of the current path. By means of this embodiment, the distribution of the electric field and of the electric field stress and the compactness of the switchgear are further improved.

According to an advantageous embodiment of the switching device according to the present invention, the switching device comprises an electrically conductive member which forms the first part of the current path between the breaker and the electrical conductor, wherein the housing houses the conductive member.

According to a further advantageous embodiment of the switching device according to the present invention, the conductive member has a first end portion and a second end portion between which the conductive member extends, wherein in the first position the switch element is electrically connected to the second end portion of the conductive member, and in the second position the switch element is electrically connected to the first end portion of the conductive member. This embodiment supports the efficient movement of the switch element between its different positions.

According to another advantageous embodiment of the switching device according to the present invention, in the third position, the switch element is electrically connected the first and second end portions of the conductive member. By means of this embodiment, the distribution of the electric field and of the electric field stress and the compactness of the switchgear are further improved.

The switch element may comprise two switch knives, which may be substantially parallel. When the switch element is connected to the conductive member, the conductive member may be sandwiched between the two switch knives, to improve the contact between the conductive member and the switch element. Advantageously, the conductive member may have an intermediate portion between the first and second end portions, and the thickness of the first and second end portions may be greater than the thickness of the intermediate portion. This embodiment supports the efficient movement of the switch element between its different positions, and supports the connection between the switch element and the conductive member.

According to still another advantageous embodiment of the switching device according to the present invention, the breaker comprises an electrically conductive first contact and an electrically conductive second contact, the second contact being movable in relation to the first contact and in relation to the housing, and when the first and second contacts are in contact, the breaker is in a closed position, and when the first and second contacts are separated, the breaker is in an open position, wherein the switching device comprises a flexible second electrical conductor electrically connecting the conductive member to the second contact. By means of this embodiment, the distribution of the electric field and of the electric field stress and the compactness of the switchgear are further improved.

According to yet another advantageous embodiment of the switching device according to the present invention, the housing is adapted to be at an electric potential which is substantially equal to the electric potential of the second contact of the breaker during the operation of the switching device. By means of this embodiment, the distribution of the electric field and the electric field stress is further improved.

According to an advantageous embodiment of the switching device according to the present invention, the housing is provided with a through-hole for suspension of the housing. Hereby, an efficient suspension of the housing is provided which does not impair the distribution of the electric field to any substantial extent.

According to a further advantageous embodiment of the switching device according to the present invention, the outer surface of the housing is smoothly curved towards and into the through-hole. By means of this embodiment, a so called triple point with high dielectric stress may be avoided. This is advantageous when using a shaft which is inserted into the through-hole.

According to another advantageous embodiment of the switching device according to the present invention, the switching device comprises a shaft inserted into the through-hole of the housing, wherein the shaft is rotatable about its longitudinal axis and in relation to the housing, wherein the shaft is connected to the at least one guiding member, and wherein the shaft and its rotation is adapted to control the movement of the at least one guiding member. By means of this embodiment, an efficient control of the breaker is provided, which does not impair the distribution of the electric field to any substantial extent. Advantageously, when each of a plurality of phases, e.g. three phases, is provided with the innovative switching device, the same shaft may be inserted into the through-hole of each housing to control the movement of the at least one guiding member of all the housings. Alternatively, instead of using said shaft to operate the breaker, two pulling/pushing rods may be used, one for opening the breaker and one for closing the breaker. Other means for controlling the breaker are also possible.

According to still another advantageous embodiment of the switching device according to the present invention, the housing is made of at least one casted part. Advantageously, the housing can be made of two casted parts which are joined by suitable means. By means of these embodiments, the breaker will be efficiently supported, and a mechanically stable switching device and system are attained.

According to yet another advantageous embodiment of the switching device according to the present invention, the housing has a smooth outer shape to distribute the electric field generated by the voltage of the current through the switching device. The outer shape, or the outer geometry, of the housing is smooth in that the housing does not have an angular outer shape, e.g. with sharp corners or edges, and is without roughness. By this embodiment, the electric field, or electric field stress, generated by the voltage of the current through the switching device is further evenly distributed in an efficient way, and the risk of flashover, discharges or arcing between the components of the switching device and between the housing and the surroundings, e.g. the housing of a switching device of another phase, or ground, is further reduced. As a result, the switchgear provided with one or a plurality of the switching devices according to the present invention can be made more compact and less bulky, and less space for the switchgear is needed. Further, any additional shielding of the electric field is avoided.

According to an advantageous embodiment of the switching device according to the present invention, the housing has an outer surface which is smooth to distribute the electric field generated by the voltage of the current through the switching device. The outer surface of the housing is smooth in that the outer surface has no roughness, projections or sharp indentations. The outer surface is evenly curved. By means of this embodiment, the even distribution of the electric field, or electric field stress, is further improved. The risk of flashover, discharges or arcing between components or units of a switchgear is further reduced, and the switchgear can have a more compact design.

The above-mentioned objects of the present invention are also attained by providing a switchgear for electric power distribution, wherein the switchgear comprises at least one switching device as provided in the claims, and/or at least one switching device according to any of the above-mentioned embodiments of the switching device. By means of the switchgear according to the present invention, a switchgear having both a compact design and a reduced risk of flashover, discharges or arcing between components or units of a switchgear is attained. Otherwise, an improved switchgear is provided for reasons stated above in connection with the disclosure of the various embodiments of the switching device according to the present invention.

According to an advantageous embodiment of the switchgear according to the present invention, the switchgear comprises an encapsulation housing the at least one switching device.

According to a further advantageous embodiment of the switchgear according to the present invention, the switchgear comprises such a switching device for each phase.

The switching device and/or the switchgear according to the present invention is/are advantageously adapted for medium and/or high voltage, e.g. 1 kV and above.

The above-mentioned embodiments and features of the switching device and the switchgear, respectively, according to the present invention may be combined in various possible ways providing further advantageous embodiments.

Further advantageous embodiments of the switching device and the switchgear according to the present invention and further advantages with the present invention emerge from the detailed description of embodiments.

### BRIEF DESCRIPTION OF THE DRAWINGS

The present invention will now be described, for exemplary purposes, in more detail by way of embodiments and with reference to the enclosed drawings, in which:

FIG. 1 is a schematic partial view of an embodiment of the switchgear according to the present including three embodiments of the switching device according to the present invention;

FIGS. 2-4 are schematic cutaway views of the embodiment of the switchgear and of one of the embodiments of the switching device of FIG. 1;

FIG. 5 is a schematic view of the exterior of the housing of the embodiment of the switching device of FIGS. 2-4;

FIG. 6 is a schematic cutaway view of the embodiment of the switching device showing the at least one guiding member for operating the breaker;

FIGS. 7-9 are schematic views of an embodiment of the switch of the switching device of FIGS. 2-6; and

FIGS. 10-11 are schematic views of an embodiment of the conductive member, which forms the first part of the current path between the breaker and the electrical conductor, of the switching device of FIGS. 2-6.

### DETAILED DESCRIPTION OF THE INVENTION

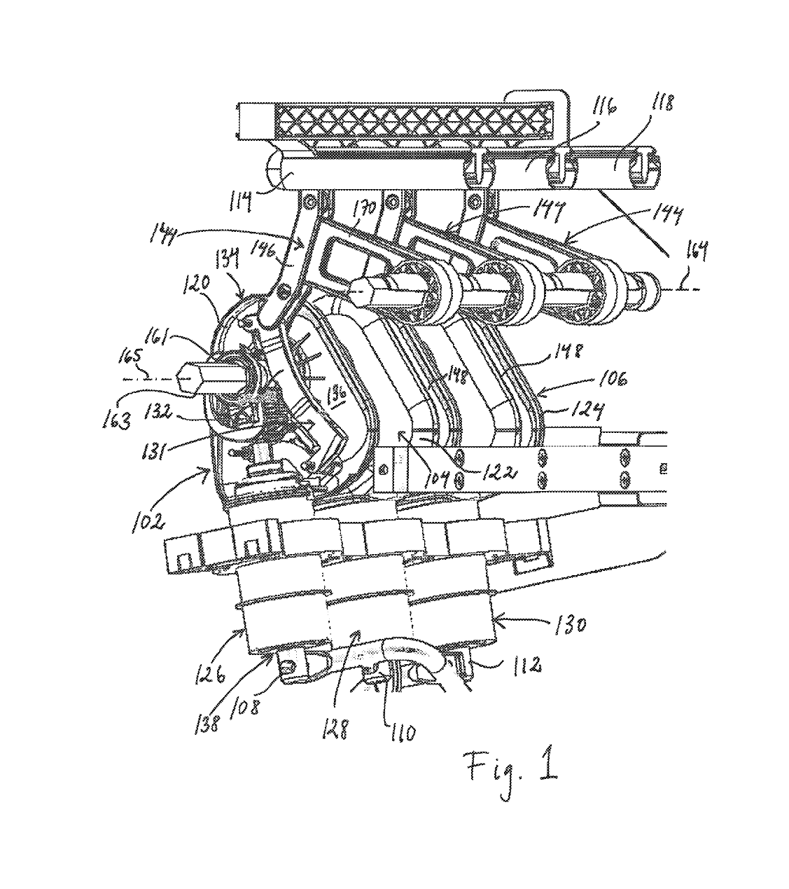

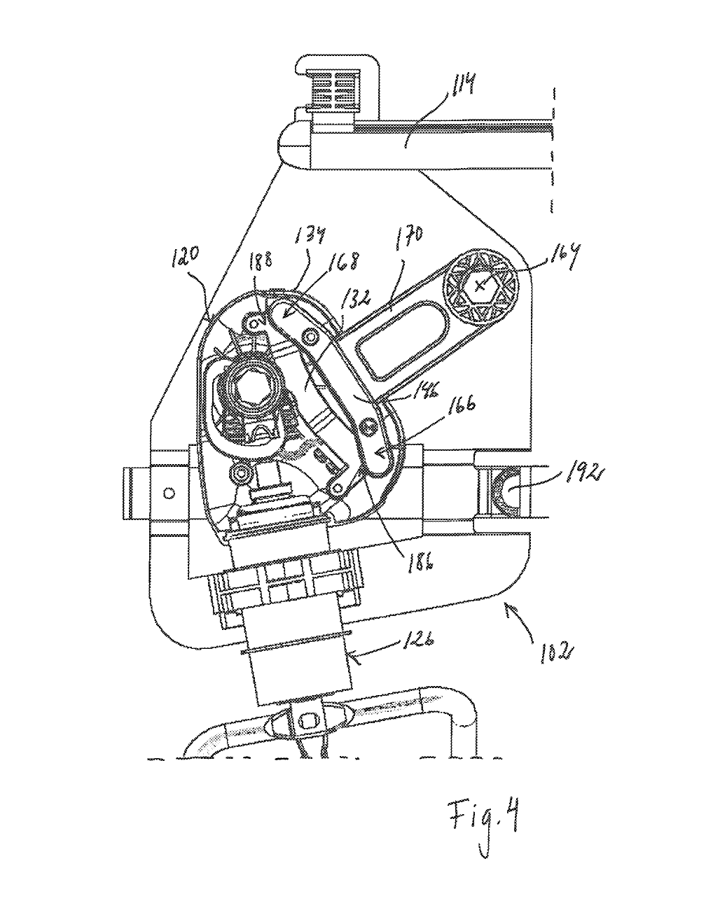

FIG. 1 schematically shows an embodiment of the switchgear according to the present having three embodiments of the switching device 102, 104, 106 for electric power distribution according to the present invention, where one of the switching devices 102 has a part of the housing cut away for illustrative purposes. The shown switchgear is an electric power distribution switchgear and comprises a plurality of switching devices 102, 104, 106 which can be housed in an encapsulation 107 (see FIG. 5). The encapsulation 107 may be penetrated by a number of electrical bushings (not shown), one for each phase of a plural phase system. From each electrical bushing, a respective conducting element 108, 110, 112 may extend to the respective switching device 102, 104, 106. On the outside of the encapsulation 107, the electrical bushings may be connected to cables (not shown) which either connect the switchgear to a load or to a medium or high voltage power distribution line.

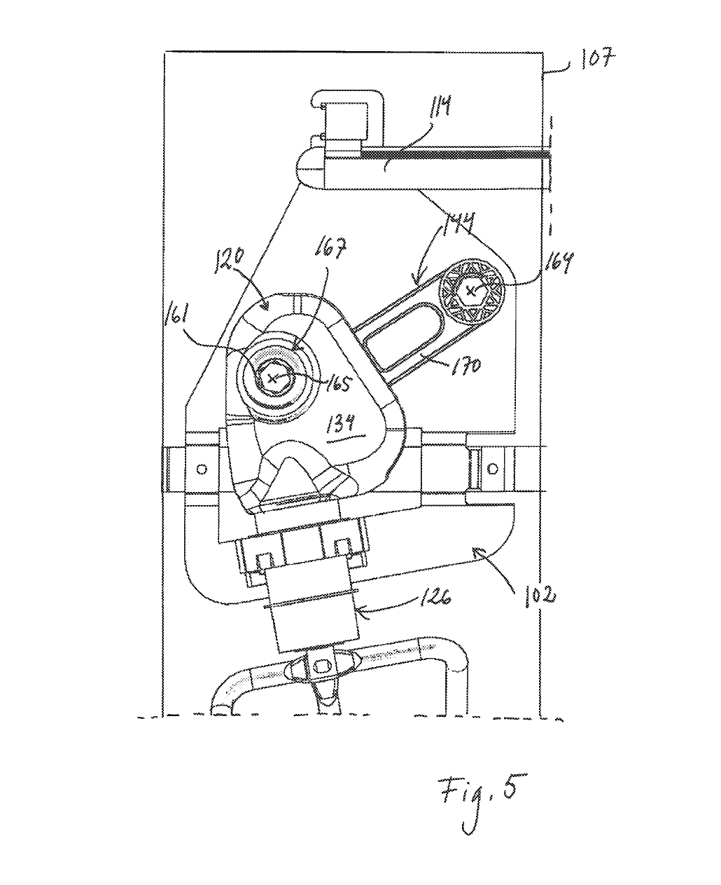

Each switching device 102, 104, 106 is electrically connectable to an electrical conductor 114, 116, 118, in the form of a busbar. Each switching device 102, 104, 106 comprises an electrically conductive housing 120, 122, 124, which may be made of metal, e.g. aluminium, or any other suitable metal, and may be made of two casted parts, and a breaker 126, 128, 130 mounted to the housing 120, 122, 124. The housing 120, 122, 124 may overlap a part of the breaker 126, 128, 130. The greater part of the breaker 126, 128, 130 is located outside of the housing 120, 122, 124. The breaker 126 may be held by a cylindrical container 129 which engages the housing 120 (see FIG. 6). The switching device 102, 104, 106 provides a current path between the breaker 126, 128, 130 and the electrical conductor 114, 116, 118. The housing 120 houses a first part 131 of the current path between the breaker 126 and the electrical conductor 114. The first part 131 of the current path is electrically connected to the breaker 126.

Each housing 120 has an outer surface 134 and an inner surface 136. The outer shape, or the outer geometry, of the housing 120, 122, 124 may be smooth to distribute the electric field generated by the voltage of the current through the switching device 102, 104, 106. The outer shape of the housing 120 is smooth in that the housing does not have an angular outer shape and is without roughness (see FIG. 5). The outer surface 134 of the housing 120 may also be smooth to distribute the electric field generated by the voltage of the current through the switching device 102, 104, 106. The outer surface 134 of the housing 120 is smooth in that the outer surface 134 has no roughness, sharp projections or sharp indentations. Each housing 120 may be made of at least one casted part, e.g. two casted parts mounted to one another.

The breaker 126, 128, 130 is in the form of a vacuum interrupter and includes in a conventional way an electrically conductive first contact (not shown) electrically connected to a first terminal 138 and an electrically conductive second contact (not shown) electrically connected to a second terminal 140. The second contact and the second terminal 140 are movable in relation to the first contact and in relation to the housing 120. When the first and second contacts are in contact the breaker 126 is in a closed (conducting) position, and when the first and second contacts are separated the breaker 126 is in an open (non-conducting) position. The breaker 126, 128, 130 is conventional and known to the skilled person and is therefore not described in more detail. It is to be understood that other breakers instead of the vacuum interrupter may also be used.

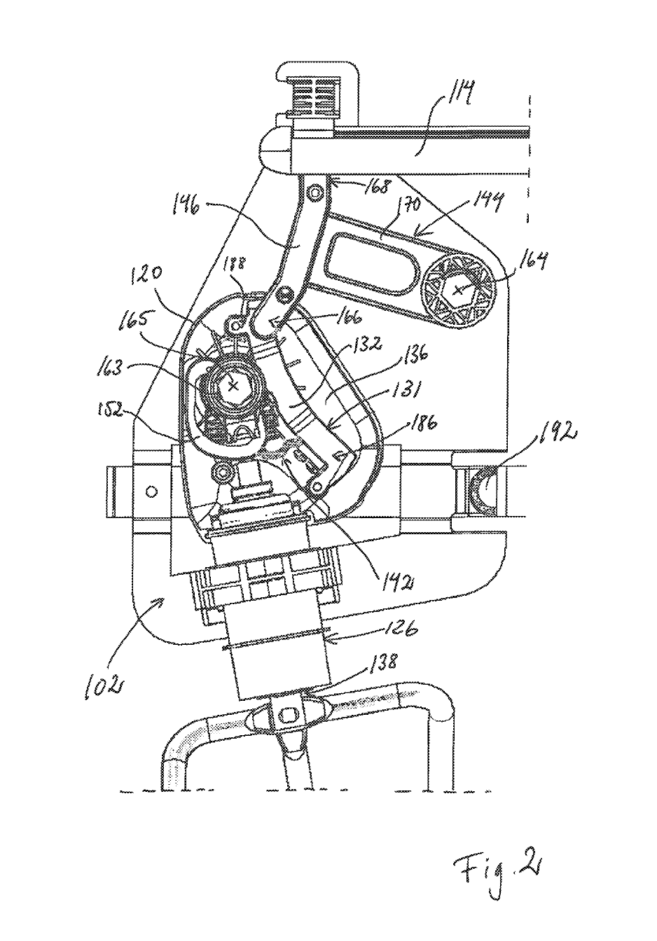

The above-mentioned first part 131 of the current path may be in the form of an electrically conductive member 132 which forms the first part 131 of the current path between the breaker 126 and the electrical conductor 114. With reference to FIGS. 2-4 and FIG. 6, the conductive member 132 may be mounted to the inner surface 136 of the housing 120. The conductive member 132 may be electrically connected to the second contact of the breaker 126 by being connected to the second terminal 140 by means of a flexible second electrical conductor 142 electrically connecting the conductive member 132 to the second contact (see FIG. 6). The conductive member 132 is electrically connectable to the electrical conductor 114 by means of a switch 144 for electrically connecting the breaker 126 to the electrical conductor 114. The switch 144 comprises an electrically conductive switch element 146. The second electrical conductor 142 and the switch element 146 may form a second part of the current path between the breaker 126 and the electrical conductor 114. Each housing 120, 122, 124 may comprise an opening 148, e.g. a slot, for receiving at least a portion of the switch element 146, to allow the switch element 146 to make contact with the conductive member 132 housed in the housing 120 (see FIG. 1). The switch element 146 may be adapted to move in the opening 148 provided in the housing 120. The conductive member 132 and the switch 144 are described in further detail herein below.

With reference to FIG. 6, the housing 120 may house a plurality of guiding members 150, 152 for operating the breaker 126. The plurality of guiding members 150, 152 may comprise a first group 150 of guiding members forming a biasing assembly 150. The biasing assembly 150 may comprise a casing 154 housing at least two biasing members 156, 158. Each biasing member 156, 158 may be in the form of a compression spring, e.g. a coil spring. The biasing assembly 150 may also be designed in other ways and may be in the form of a single biasing member, e.g. a coil spring, or any other spring means, e.g. a dish spring etc. The biasing assembly 150 is connected to, but electrically insulated from, the second contact of the breaker 126 and is adapted to bias the second contact against the first contact when the breaker 126 is in the closed position. The biasing assembly 150 is axially movable in relation to the housing 120. Further, the plurality of guiding members comprises a pivoting arm 152 which is rotatable about a pivot axis 159. The biasing assembly 150 is connected to the pivoting arm 152, and the rotation of the pivoting arm 152 effects the axial movement of the biasing assembly 150. The axial movement of the biasing assembly 150 effects the axial movement of the second contact of the breaker 126. The biasing assembly 150 may be indirectly connected to the second contact via an axially movable guiding rod, which may be insulated from the second terminal 140 and from the second contact of the breaker 126.

Each housing 120 may be provided with a through-hole 161 for suspension of the housing 120. A shaft 163 may be inserted into the through-hole 161 of each housing 120. The outer surface 134 of the housing 120 may be smoothly curved towards and into the through-hole 161. By said smooth curvature 167 of the outer surface 134 towards and into the through-hole 161, a so called triple point with high dielectric stress may be avoided. The shaft 163 is rotatable about its longitudinal axis 165, which is coaxial with the pivot axis 159 of the pivoting arm 152, and in relation to the housing 120. The shaft 163 is connected to the pivoting arm 152. The rotation of the shaft 163 causes the pivoting arm 152 to rotate. The shaft 163 is adapted to control the movement of the second contact of the breaker 126 by controlling the rotation of the pivoting arm 152 and thereby controlling the axial movement of the biasing assembly 150.

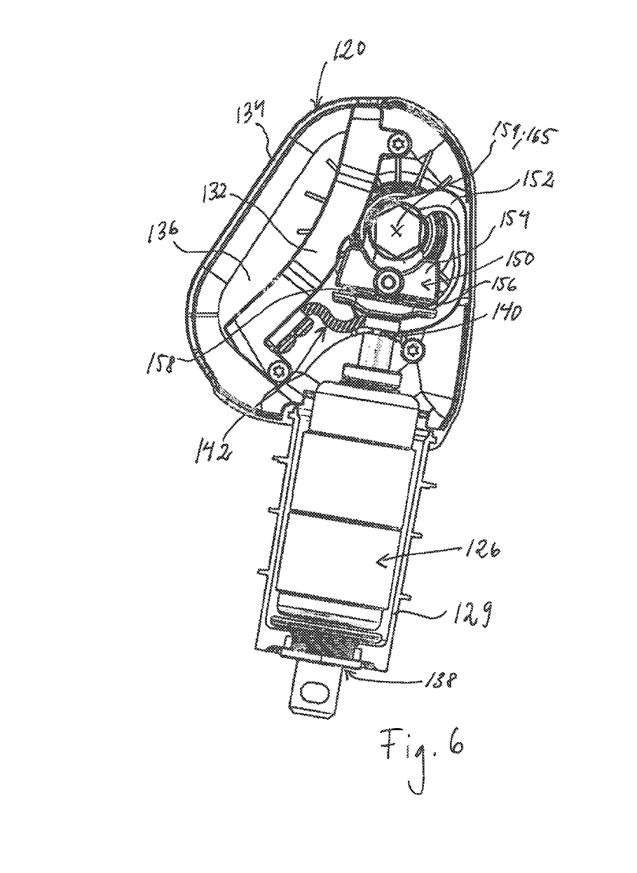

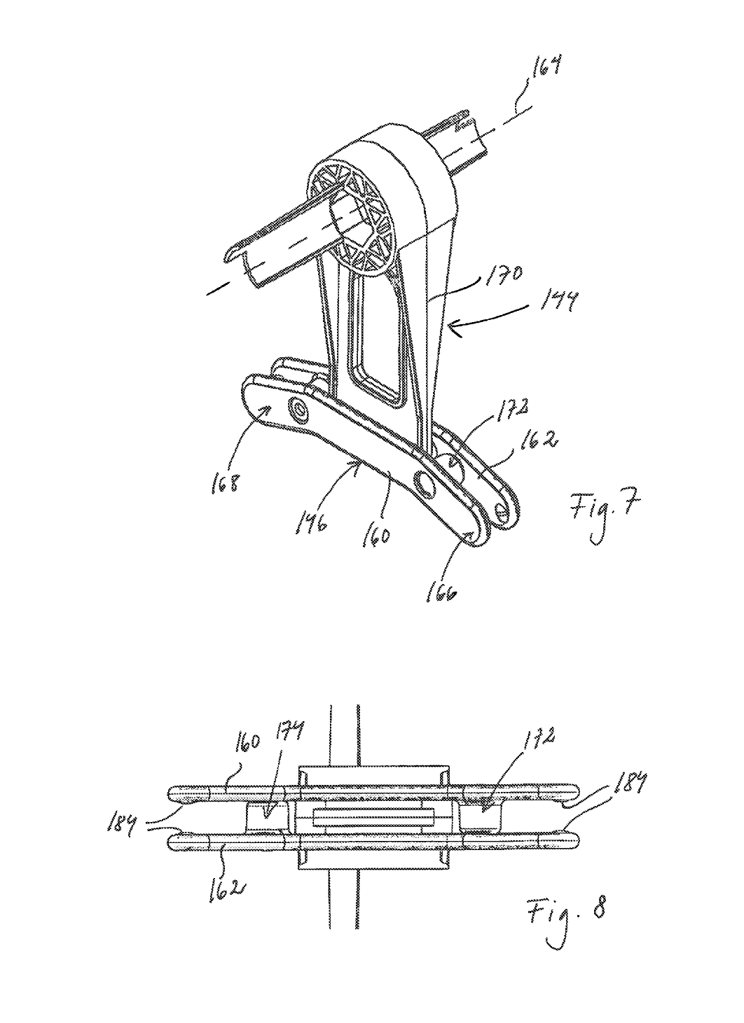

With reference to FIGS. 7-8, the above-mentioned switch 144 is schematically shown in more detail. As mentioned above, the switch 144 comprises a switch element 146. The switch element 146 may comprise two electrically conductive switch knives 160, 162 which may be substantially parallel to one another. When connected to the conductive member 132, the switch element 146 may be arranged to receive the conductive member 132 between the two switch knives 160, 162 to provide an efficient contact. Alternatively, the switch element may comprise a single switch knife. The switch element 146 is pivotable about an axis of rotation 164. The switch element 146 may have first end portions 166 and second end portions 168 between which the switch element 146 extends. The axis of rotation 164 of the switch element 146 is located outside of the switch element 146. The switch element 146 may have an elongated extension, and the switch element 146 may be displaced from the axis of rotation 164 of the switch element 146. Alternatively, the axis of rotation of the switch element may intersect the switch element. The switch element 146 may extend non-linearly from the first end portion 166 to the second end portion 168. The switch element 146 may be pivotally mounted to its axis of rotation 164, located outside the housing 120, via an intermediate element 170 which connects the switch element 146 to the axis of rotation 164. With reference to FIG. 8, which shows the switch element 146 as viewed from below, the two switch knives 160, 162 may be connected to one another by connection means 172, 174. With reference to FIG. 9, a cross-section of a connection means 172 is shown. Each connections means 172 may comprise a hollow protrusion 176 integral with one of the switch knives 160. The protrusion 176 abuts the other switch knife 162. Each connections means 172 may comprise an attachment element 178 and a compression spring 180. The compression spring 180 is housed in an inner space 182 of the hollow protrusion 176 and is held in place by the attachment element 178. The attachment element 178 may extend axially inside the inner space 182 of the hollow protrusion 176 and may be attached to the other switch knife 162. The compression spring 180 may surround the attachment element 178. By means of the connections means 172, 174, the switch knives 160, 162 may be efficiently biased against the conductive member 132 and an efficient contact between the switch element 146 and the conductive member 132 is attained. Further, each switch knife 160, 162 may have projections 184 to further enhance the contact between the switch element 146 and the conductive member 132.

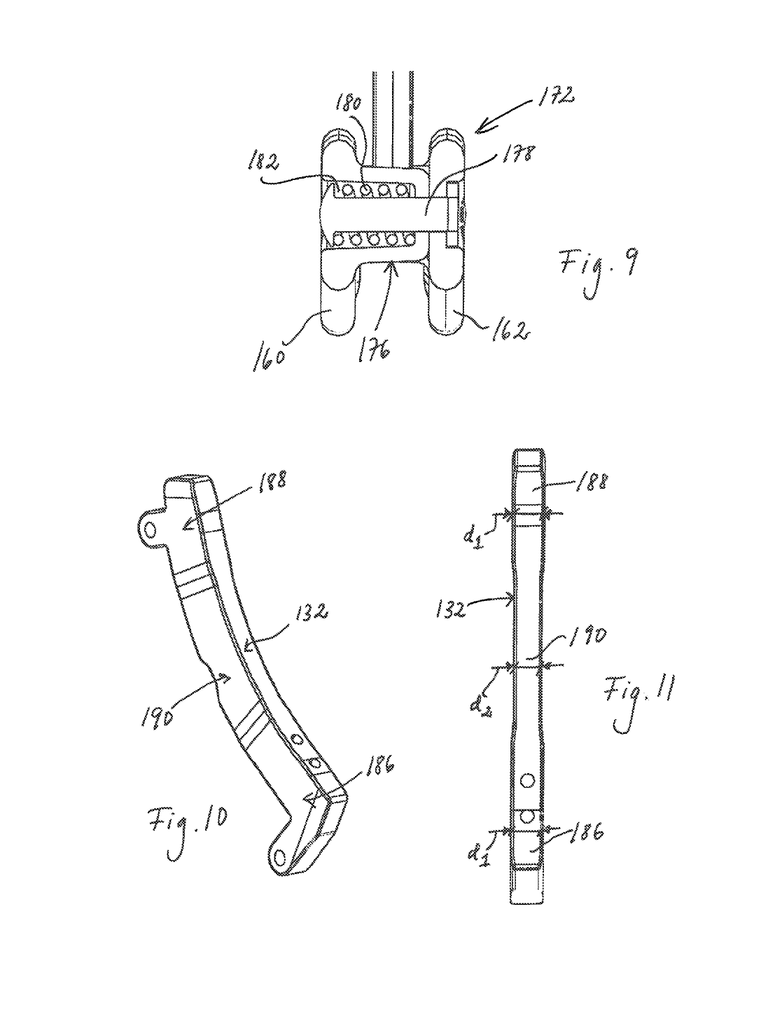

With reference to FIGS. 10-11, the above-mentioned conductive member 132 is schematically shown in more detail. The conductive member 132 may be slightly curved. The conductive member 132 may have a first end portion 186 and a second end portion 188 between which the conductive member 132 extends. The conductive member 132 may have an intermediate portion 190 between the first and second end portions 186, 188, and the thickness d₁ of the first and second end portions 186, 188 may be greater than the thickness d₂ of the intermediate portion 190. By the difference in thickness between the intermediate portion 190 and the end portions 186, 188, the movement of the switch element 146 is facilitated and improved.

With reference to FIGS. 2-5, the operation of the switch 144 is illustrated in more detail. In FIGS. 2-5, the switching device 102 of only one phase is shown. The switching devices 104, 106 not shown in FIGS. 2-5 are arranged in parallel with the one shown and are thus either hidden behind the one shown or located in planes in front of the latter. The switch element 146 of the switch 144 is movable to a first position in which the switch element 146 is physically connected and electrically connected to the first part 131 of the current path, i.e. to the conductive member 132, and to the electrical conductor 114, and thereby providing a current path between the breaker 126 and the electrical conductor 114. In the first position the switch element 146 may be electrically connectable to an electrical conductor 114 located outside of the housing 120. The first position of the switch element 146 is illustrated in FIG. 2 (and also in FIG. 1). In the first position the first end portion 166 of the switch element 146 may be arranged to be physically connected and electrically connected to the conductive member 132, more precisely to the second end portion 188 of the conductive member 132, and the second end portion 168 of the switch element 146 may be arranged to be physically connected and electrically connected to the electrical conductor 114.

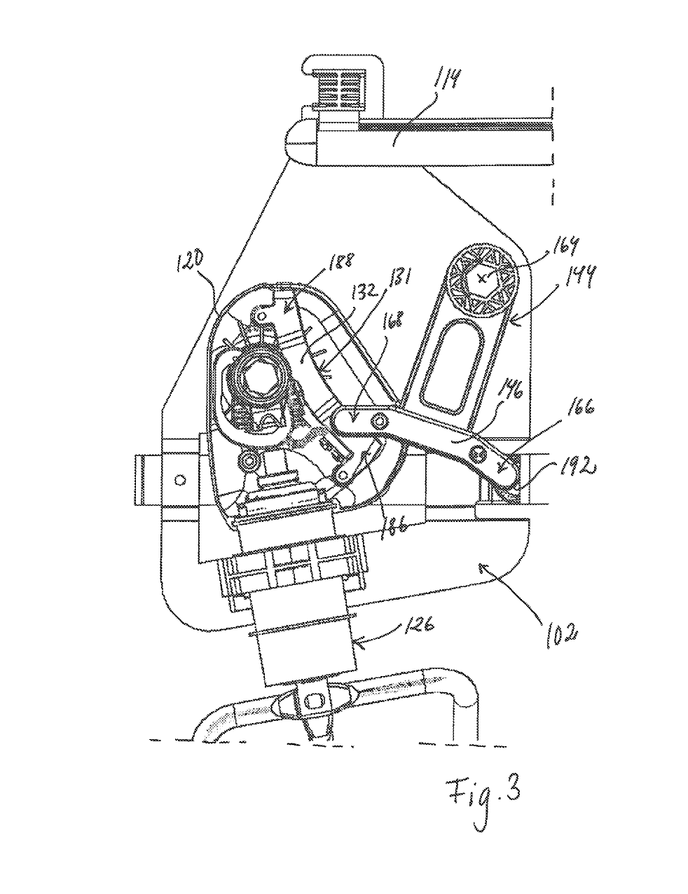

The switch element 146 of the switch 144 is movable to a second position in which the switch element 146 is disconnected from the electrical conductor 114 and physically connected and electrically connected to the conductive member 132 and to a grounded/earthed element 192. The second position of the switch element 146 is illustrated in FIG. 3. In the second position, the second end portion 168 of the switch element 146 may be arranged to be physically connected and electrically connected to the conductive member 132, more precisely to the first end portion 186 of the conductive member 132, and the first end portion 166 of the switch element 144 may be arranged to be physically connected and conductively connected to the grounded element 192.

The switch element 146 of the switch 144 is movable to a third position in which the switch element 146 is disconnected from the electrical conductor 114 and disconnected from the grounded element 192. The third position of the switch element 146 is illustrated in FIG. 4. In the third position, the switch element 146 may be arranged to be physically connected and electrically connected to the conductive member 132. In the third position the first and second end portions 166, 168 of the switch element 146 may be physically connected and electrically connected to the conductive member 132, more precisely, to the first and second end portions 186, 188 of the conductive member 132. In the third position, the switch element 146 may be situated within the outer surface 134 of the housing 120.

As previously mentioned, advantageously, the switch element 146 is pivotable about the axis of rotation 164 and pivotable between the first, second and third positions. The axis of rotation 164 of the switch element 146 may be located outside of the outer surface 134 of the housing 120.

The grounded element 192 and the electrical conductor 114 may be arranged to engage the space between to the two switch knives 160, 162 of the switch element 146, to attain an efficient contact.

FIG. 5 shows the exterior of the housing 120 shown in FIGS. 2-4, when the switch element 146 is in the third position, as shown in FIG. 4, and thus is disconnected from the electrical conductor 114 and from the grounded element 192 and situated within the outer surface 134 of the housing 120. As mentioned above, the outer shape of the housing 120 and the outer surface 134 of the housing 120 are smooth to distribute the electric field generated by the voltage of the current through the switching device 102.

The switch 144 acts as a so called safety switch, or selector switch, which is not adapted to break a medium or high voltage circuit itself, but is adapted to disconnect the breaker from a medium or high voltage line after breaking has been performed by means of the breaker 126. The reasons for having a three-position switch element in a switchgear are well known to persons skilled in the art and are not described in more detail herein. The second position of the switch 144 may be regarded as a safety position, enabling safe repair and service on components such as cables connected to the switchgear. The third position may be regarded as a switched-off position.

By the innovative design of the switch 144, the distribution of the electric field and the electric field stress is improved, and enables a switchgear with a compact design.

Each housing of the embodiments described above may be adapted to be at an electric potential which is substantially equal to the electric potential of the second contact of the breaker during the operation of the switching device.

It is to be understood that the switchgear may comprise a plurality of switchgears, or units, such as the one described above. For each electric phase there may be a common bus bar, like the electrical conductor described above, which extends from unit to unit. The encapsulation may or may not be common for the plurality of switchgears/units. The encapsulation may be filled with an electrically insulating gas or gas mixture, which may be pressurised. Air-filled encapsulations are also possible.

Alternative designs of the arrangement of the three position switch and the current path of the switching device is disclosed in the European patent application No. 09179639.1, which is hereby incorporated by reference.

The invention shall not be considered limited to the embodiments illustrated, but can be modified and altered in many ways by one skilled in the art, without departing from the scope of the appended claims.

1. A switching device for electric power distribution, electrically connectable to an electrical conductor, the switching device comprising:
a breaker, the breaker being electrically connectable to the electrical conductor,
a housing to which the breaker is mounted, the housing being at least partially electrically conductive and having an outer surface, and
a current path between the breaker and the electrical conductor,
wherein the housing houses at least one guiding member for operating the breaker, the at least one guiding member being movable in relation to the housing,
the housing houses a first part of the current path between the breaker and the electrical conductor, the first part of the current path being electrically connected to the breaker, and
the switching device further comprises a switch for electrically connecting the breaker to the electrical conductor, the switch having a switch element that is movable to a first position in which the switch element is electrically connected to the first part of the current path and to the electrical conductor, movable to a second position in which the switch element is disconnected from the electrical conductor and electrically connected to the first part of the current path and to a grounded element, and movable to a third position in which the switch element is disconnected from the electrical conductor and from the grounded element.

2. The switching device according to claim 1, wherein, in the first position, the switch element is electrically connectable to the electrical conductor located outside of the housing.

3. The switching device according to claim 1, wherein, in the third position, the switch element is disposed within the outer surface of the housing.

4. The switching device according to claim 1, wherein, in the third position, the switch element is electrically connected to the first part of the current path.

5. The switching device according to claim 1, wherein the switch element is pivotable about an axis of rotation between the first, second and third positions.

6. The switching device according to claim 5, wherein the axis of rotation of the switch element is located outside of the outer surface of the housing.

7. The switching device according to claim 5, wherein the axis of rotation of the switch element is located outside of the switch element.

8. The switching device according to claim 1, wherein the switch element has a first end portion and a second end portion between which the switch element extends, in that in the first position the first end portion of the switch element is electrically connected to the first part of the current path and the second end portion of the switch element is electrically connected to the electrical conductor, and in that in the second position the second end portion of the switch element is disconnected from the electrical conductor and electrically connected to the first part of the current path and the first end portion of the switch element is electrically connected to the grounded element.

9. The switching device according to claim 8, wherein the switch element extends non-linearly from the first end portion to the second end portion.

10. The switching device according to claim 8, wherein, in the third position, the first and second end portions of the switch element are electrically connected to the first part of the current path.

11. The switching device according to claim 1, further comprising an electrically conductive member which forms the first part of the current path between the breaker and the electrical conductor, wherein the housing houses the conductive member.

12. The switching device according to claim 11, wherein the conductive member has a first end portion and a second end portion between which the conductive member extends, in that in the first position the switch element is electrically connected to the second end portion of the conductive member, and in that in the second position the switch element is electrically connected to the first end portion of the conductive member.

13. The switching device according to claim 12, wherein, in the third position, the switch element is electrically connected the first and second end portions of the conductive member.

14. The switching device according to claim 11, wherein the breaker comprises an electrically conductive first contact and an electrically conductive second contact, the second contact being movable in relation to the first contact and in relation to the housing, the breaker is in a dosed position when the first and second contacts are in contact, and the breaker is in an open position when the first and second contacts are separated, and
wherein the switching device further comprises a flexible second electrical conductor electrically connecting the conductive member to the second contact.

15. The switching device according to claim 1, wherein the housing is made of at least one casted part.

16. The switching device according to claim 1, wherein the housing has a smooth outer shape to distribute an electric field generated by the voltage of the current through the switching device.

17. A switchgear for electric power distribution, wherein the switchgear comprises at least one switching device as claimed in claim 1.

18. The switchgear according to claim 17, further comprising an encapsulation housing the at least one switching device.
